(19) United States
(12) Patent Application Publication
(10) Pub. No.: US 2001/0051024 A1
(43) Pub. Date: Dec. 13, 2001

(54) Optical fiber connecting sleeve and method of producing the same

(76) Inventor: Kohei Narishige, Tokyo (JP)

Correspondence Address: JACOBSON, PRICE, HOLMAN & STERN, PROFESSIONAL LIMITED LIABILITY COMPANY, 400 SEVENTH STREET, N.W., WASHINGTON, DC, 20004, US

(21) Appl. No.: 09/878,353

(22) Filed: Jun. 12, 2001

(30) Foreign Application Priority Data
Jun. 12, 2000 (JP) 2000-174673

(51) Int. Cl. G02B 6/38

(52) U.S. Cl. 385/70

(57) ABSTRACT

An optical fiber connecting sleeve (10) is constructed of a cylindrical portion (11) provided with a clearance (12). This clearance (12) extends in a longitudinal direction of the sleeve (10). The closer a circumferential distance away from the clearance (12) toward a circumferentially intermediate portion (15) of the cylindrical portion (11) approaches a half a circumferential length of the cylindrical portion (11), the more the wall thickness of the cylindrical portion (11) increases. Optical fiber connectors (50) are inserted into the opposite end portions of the cylindrical portion (11) and brought into abutting contact with each other in an axially intermediate portion of the cylindrical portion (11) in a manner such that misalignment in axis of the optical fibers (52) of the connectors (50) is minimized. As a result, the light coupling loss in the abutting contact of the optical fibers (52) is reduced in comparison with the prior art. This realizes a high-quality telecommunication environment.

### BACKGROUND OF THE INVENTION

1. Field of the Invention

The present invention relates to: an optical fiber connecting sleeve, which is used in connecting a pair of optical fibers with each other in an abutting manner; and, a method of producing the optical fiber connecting sleeve. More particularly, the present invention relates to the optical fiber connecting sleeve in construction, which is capable of reducing the light coupling loss when the optical fibers are connected with each other by using the optical fiber connecting sleeve.

2. Description of the Related Art

In general, as shown in FIG. 4, an optical fiber connector 50 is constructed of a cylindrical ferrule 51 and an optical fiber 52 coaxially disposed in a radially central area of the ferrule 51. Heretofore, when the optical fibers 52 are connected with each other in an abutting manner, the optical fiber connector 50 is inserted into each of opposite end portions of a conventional-type cylindrical connecting sleeve 40 in a manner such that the connectors 50 are brought into abutting contact with each other in a substantially axially intermediate portion of the connecting sleeve 40.

As shown in FIG. 3, the conventional connecting sleeve 40 is provided with a slit portion 42. This slit portion 42 is constructed of a clearance extending in a longitudinal direction of a cylindrical portion 41 of the connecting sleeve 40. The conventional sleeve 40 has its inner diameter be slightly smaller than an outer diameter of the optical fiber connector 50.

In order to suppress the light coupling loss, preferably the optical fibers 52 are connected with each other in an abutting manner in a condition in which they have their axes completely aligned with each other in cross section.

As described above, since the connecting sleeve 40 has its inner diameter be slightly smaller than the outer diameter of the optical fiber connector 50, the optical fiber connector 50 is capable of resiliently radially expanding the inner diameter of the connecting sleeve 40 when inserted into the connecting sleeve 40, and therefore capable of being held in a desired position of the interior of the connecting sleeve 40 thus radially expanded.

However, such radial expansion of the connecting sleeve 40 due to the insertion of the optical fiber connectors 50 into the opposite end portions of the connecting sleeve 40 affects the inner circumferential contour (hereinafter referred to simply as the “inner diameter”) of the connecting sleeve 40 in roundness in cross section, which causes the optical fibers 52 to be misaligned with the other in center line or axis (see FIG. 4). Such misalignment in axis of the optical fibers 52 leads to the light coupling loss. This is a problem inherent in the conventional connecting sleeve 40.

### SUMMARY OF THE INVENTION

Under such circumstances, the present invention was made. Consequently, it is an object of the present invention to realize a high-quality telecommunication environment by providing an optical fiber connecting sleeve, which is capable of reducing the light coupling loss in comparison with a conventional-type optical fiber connecting sleeve, and further by providing a method of producing the optical fiber connecting sleeve of the present invention.

In other words, the optical fiber connecting sleeve of the present invention is characterized in that: the connecting sleeve is constructed of a cylindrical portion provided with a slit portion which extends in a longitudinal direction of the cylindrical portion; and, the closer a circumferential distance away from the slit portion toward a circumferential intermediate portion of the cylindrical portion in cross section approaches a half a circumferential length of the cylindrical portion, the more a wall thickness of the cylindrical portion increases.

Further, in the optical fiber connecting sleeve of the present invention comprising the cylindrical portion: the cylindrical portion is provided with the slit portion which extends in a longitudinal direction of the cylindrical portion; and, a center point of an inner diameter of the cylindrical portion is deviated from a center point of an outer diameter of the cylindrical portion in cross section.

In the connecting sleeve comprising the cylindrical portion provided with the slit portion extending in the longitudinal direction of the cylindrical portion, since the wall thickness of the cylindrical portion becomes thicker as the circumferential distance away from the slit portion toward the circumferentially intermediate portion of the cylindrical portion increases as descried above, it is substantially possible for the cylindrical portion of the present invention in contrast with the prior art to keep the roundness of its inner diameter even when the inner diameter of the cylindrical portion is radially expended by the insertion of the optical fiber connectors 50 into the opposite end portions of the cylindrical portion.

On the other hand, a method of the present invention for producing the optical fiber connecting sleeve comprises the steps of: forming a plate-like segment, wherein the plate-like segment is provided with a lower flat surface and an upper convex surface to define a wall thickness therebetween in cross section and has its intermediate portion be larger in wall thickness than each of its opposite end portions; and, bending the plate-like segment downward to form a cylindrical portion in a manner such that the opposite end portions of the plate-like segment are oppositely disposed from each other through a clearance, wherein the clearance extends in a longitudinal direction of the cylindrical portion.

Another method of the present invention for producing the optical fiber connecting sleeve comprises the steps of: forming a plate-like preform, wherein the plate-like preform is provided with a lower flat surface and a upper convex surface to define a wall thickness therebetween in cross section and has its intermediate portion be larger in wall thickness than each of its opposite end portions; dividing the plate-like preform along a plurality of cutting planes into a plurality of plate-like segments each of which is provided with a lower divided flat surface and an upper divided convex surface, where in an upper end line of the cutting plane appears in the upper divided convex surface of the plate-like segment to extend over the entire length of each of the upper divided convex surfaces, the lower divided flat surface being provided with a tapered surface adjacent to the cutting plane; and, bending the plate-like segment downward to form a cylindrical portion as a whole in a manner such that the opposite end portions of the plate-like segment are oppositely disposed from each other through a clearance, wherein the clearance extends in a longitudinal direction of the cylindrical portion.

### BRIEF DESCRIPTION OF THE DRAWINGS

The above and other objects, advantages and features of the present invention will be more apparent from the following description taken in conjunction with the accompanying drawings in which:

FIG. 1(a) is a perspective view of an embodiment of an optical fiber connecting sleeve of the present invention;

FIG. 1(b) is a front view of the connecting sleeve shown in FIG. 1(a);

FIG. 1(c) is a longitudinal sectional view of an axial end portion of the connecting sleeve shown in FIG. 1(a);

FIG. 2(a) is a perspective view of an embodiment of a plate-like preform of the optical fiber connecting sleeve shown in FIG. 2(a);

FIG. 2(b) is a side view of a part of the plate-like preform shown in FIG. 2(a);

FIG. 2(c) is a side view of a plate-like segment having been divided from the plate-like perform shown in FIG. 2(a);

FIG. 3 is a perspective view of an optical fiber connecting sleeve of a conventional type; and

FIG. 4 is a longitudinal sectional view of the optical fiber connectors inserted into the conventional optical fiber connecting sleeve so as to be brought into abutting contact with each other in the sleeve.

### DETAILED DESCRIPTION OF THE PREFERRED EMBODIMENTS

With reference to the accompanying drawings, the best modes for carrying out the present invention will be described in detail using embodiments of the present invention.

The present invention may, however, be embodied in various different forms and should not be construed as limited to the embodiments set forth herein; rather, these embodiments are provided so that this disclosure will be thorough and complete, and will fully convey the scope of the present invention to those skilled in the art.

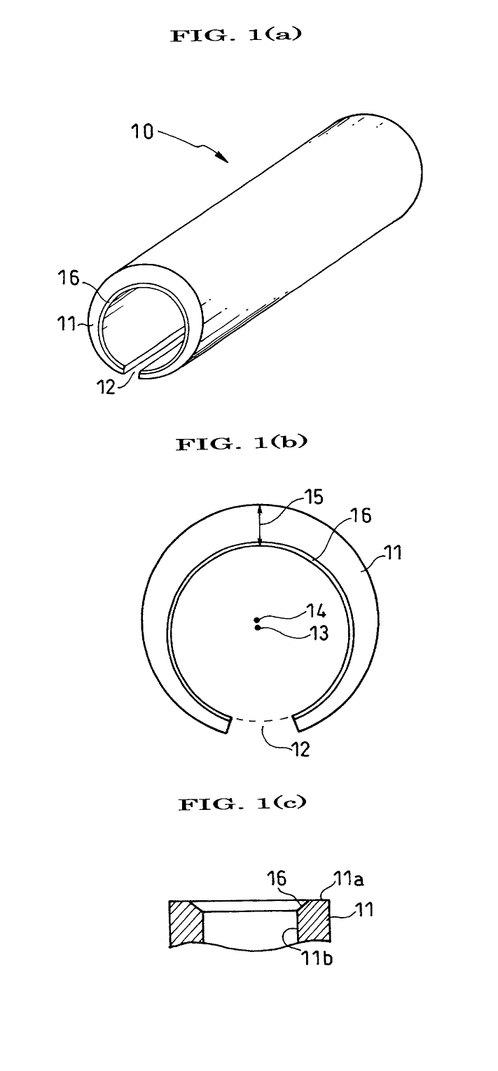

Now, an embodiment of an optical fiber connecting sleeve 10 of the present invention will be described with reference to FIGS. 1(a), 1(b) and 1(c), wherein: FIG. 1(a) shows a perspective view of the connecting sleeve 10; FIG. 1(b) shows a front view of the connecting sleeve 10; and, FIG. 1(c) shows a longitudinal sectional view of an axial end portion of the connecting sleeve 10.

The optical fiber connecting sleeve 10 is constructed of a cylindrical portion 11 as a whole. The cylindrical portion 11 is provided with a slit portion 12 extending in a longitudinal direction of the cylindrical portion 11. Further, the cylindrical portion 11 has its wall thickness designed in a manner such that the cylindrical portion 11 has a center point of its inner diameter (hereinafter referred to as the inner diameter center) 13 radially deviated from a center point of its outer diameter (hereinafter referred to as the outer diameter center) 14. In other words, the wall thickness of the cylindrical portion 11 is designed as follows: namely, as is clear from FIG. 1(b), the closer a circumferential distance away from the slit portion 12 toward a circumferentially intermediate portion 15 of the cylindrical portion 11 approaches a half a circumferential length of the cylindrical portion 11, the more the wall thickness of the cylindrical portion 11 increases to reach its maximum value in the intermediate portion 15. In the cylindrical portion 11 having the above construction, the circumferentially intermediate portion 15 of the cylindrical portion 11 is oppositely disposed from the slit portion 12 so that the wall thickness of the cylindrical portion 11 reaches a maximum value in the intermediate portion 15.

Due to the above construction of the cylindrical portion 11 in wall thickness, in the case where the inner diameter of the cylindrical portion 11 is radially expanded, it is possible to distribute stress over the entire cylindrical portion 11 in a manner such that: the stress, which is produced in the direction of the wall thickness (i.e., in a radial direction) of the cylindrical portion 11, serves to recover the cylindrical portion 11 from its deformation in roundness in cross section.

Further, as shown in FIG. 1(c), the cylindrical portion 11 is provided with a tapered portion 16 in each of its opposite end portions. This tapered portion 16 is constructed of an oblique surface through which an axial end surface 11a of the cylindrical portion 11 is connected with an inner peripheral surface 11b of the cylindrical portion 11.

In function, the tapered portion 16 of the cylindrical portion 11 facilitates the insertion of the optical fiber connector 50 (shown in FIG. 4) into the cylindrical portion 11 through the end portion of the cylindrical portion 11.

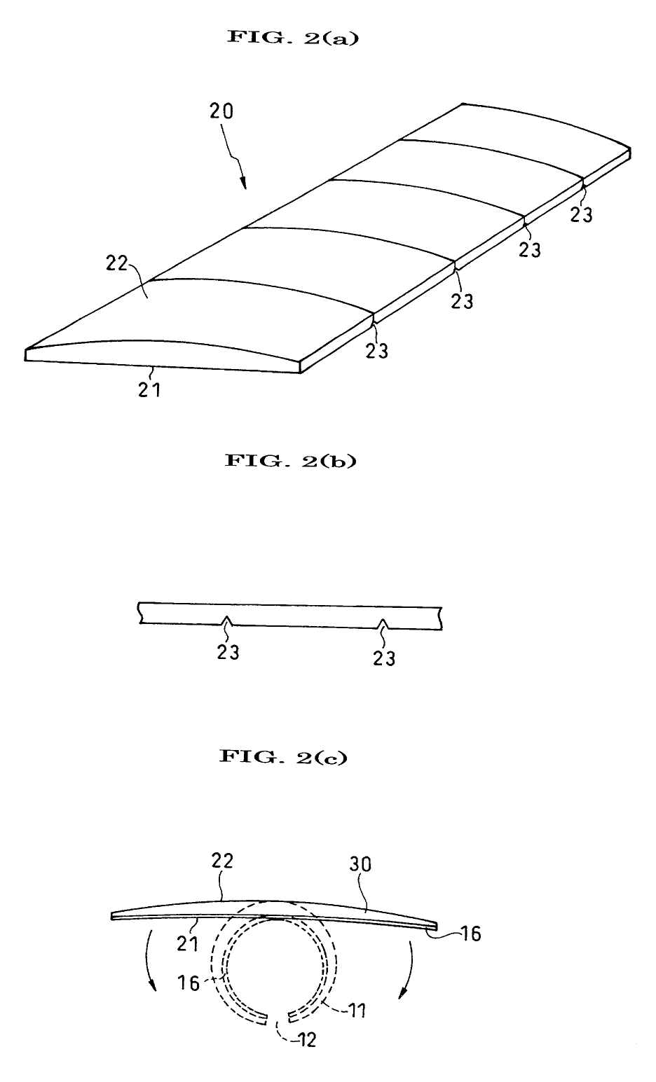

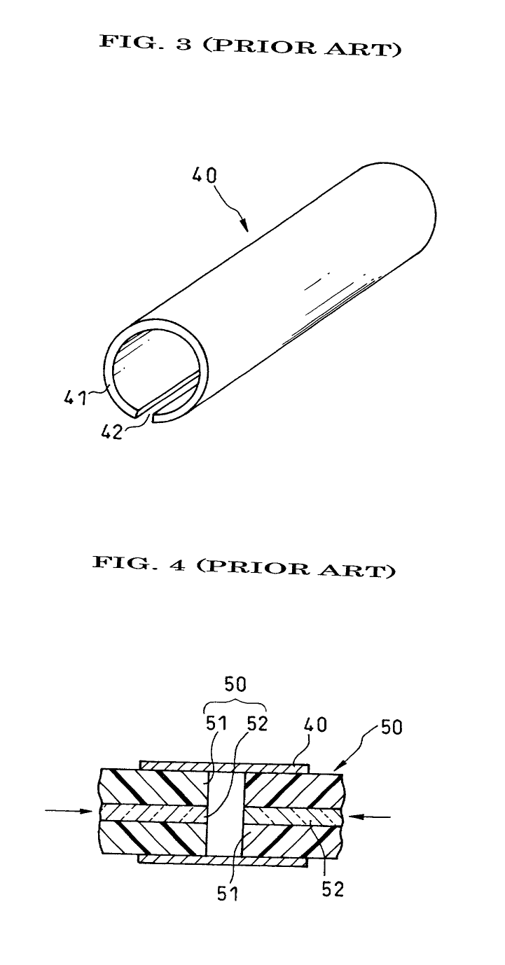

Now, with reference to FIGS. 2(a), 2(b) and 2(c), a method of producing the optical fiber connecting sleeve 10 having the above construction will be described.

First, a plate-like preform 20, from which a plurality of plate-like segments 30 for producing the optical fiber connecting sleeves 10 are obtained, is prepared. As shown in FIG. 2((a), in this plate-like preform 20: the closer a distance away from each of opposite end portions of the preform 20 toward its intermediate portions in cross section approaches a half a width of the preform 20, the more the wall thickness of the preform 20 increases. In other words, the plate-like preform 20 is provided with a lower flat surface 21 and an upper convex (or curved) surface 22.

By cutting this preform 20 along the curved surface 22, a plurality of the plate-like segments 30 are formed. Each of these plate-like segments 30 assumes the same shape as that of the pattern for the optical fiber connecting sleeve 10. As shown in FIG. 2(b), prior to performing such cutting operations, a plurality of Valley-shaped (hereinafter referred to as the V-shaped) groove portions 23 are previously formed in the lower flat surface 21 of the preform 20 by press working conducted in the individual cutting planes of the preform 20. When the preform 20 is divided into the plurality of plate-like segments 30 by cutting, the V-shaped groove portion 23 of each of the segments 30 becomes a tapered portion (i.e., tapered surface) 16 disposed adjacent to the lower flat surface 21 of the segment 30, as shown in FIG. 2(c).

The plate-like segment 30 thus obtained in the above process step is then bent downward into a circular shape in cross section as a whole, as shown in dotted lines in FIG. 2(c). As a result, the opposite end portions of the plate-like segment 30 having been bent to form the cylindrical portion 11 are oppositely disposed from each other through a clearance which forms the slit portion 12 of the cylindrical portion 11, so that the optical fiber connecting sleeve 10 constructed of the cylindrical portion 11 is formed. Consequently, in this connecting sleeve 10: as is clear from FIGS. 1(b) and 2(c), the closer a circumferential distance away from the slit portion 12 toward the circumferentially intermediate portion 15 of the cylindrical portion 11 approaches a half a circumferential length of the cylindrical portion 11, the more the wall thickness of the cylindrical portion 11 increases to reach its maximum value at the circumferentially intermediate portion 15.

Consequently, in the case where the inner diameter of the cylindrical portion 11 is radially expanded by the insertion of the optical fiber connector 50 into the cylindrical portion 11, it is possible to distribute the stress over the entire cylindrical portion 11 in a manner such that: the stress, which is produced in the direction of the wall thickness (i.e., in a radial direction) of the cylindrical portion 11, helps the cylindrical portion 11 recover from its deformation in roundness in cross section, because: the connecting sleeve 10 has the above construction in which the sleeve 10 is constructed of the cylindrical portion 11 provided with the slit portion 12 extending in the longitudinal direction of the cylindrical portion 11; and, the wall thickness of the cylindrical portion 11 increases as the circumferential distance away from the slit portion 12 toward the circumferentially intermediate portion 15 of the cylindrical portion 11 increases.

As a result, when the optical fiber connector 50 (see FIG. 4) is inserted into each of the opposite end portions of the cylindrical portion 11, it is possible for the optical fiber connecting sleeve 10 shown in FIG. 1(a) to minimize misalignment in axis between the optical fibers 52 of the connectors 50, provided that each of the optical fibers 52 is disposed in the center of each of the connectors 50 in cross section and brought into abutting contact with each other in an axially intermediate portion of the cylindrical portion 11. This leads to reduction in light coupling loss.

More specifically, it has been confirmed: that the light coupling loss has a value of less than 0.2 dB when the optical fibers 52 are connected with each other by using the connecting sleeve 10 having the above construction; and, that such light coupling loss of less than 0.2 dB realizes a high-quality telecommunication environment since the prior art is not able to realize reduction of light coupling loss of less than 0.35 dB.

Further, in the method of producing the connecting sleeve 10, by using a simple bending process for bending the plate-like segment 30 which has its circumferentially intermediate portion 15 be thicker in wall thickness than each of its circumferentially opposite end portions, it is possible to produce the optical fiber connecting sleeve 10 of the present invention which is low in light coupling loss.

What is claimed is:

1. An optical fiber connecting sleeve (10) comprising a cylindrical portion (11), wherein: said cylindrical portion (11) is provided with a slit portion (12) which extends in a longitudinal direction of said cylindrical portion (11); and, the closer a circumferential distance away from said slit portion (12) toward a circumferentially intermediate portion (15) of said cylindrical portion (11) in cross section approaches a half a circumferential length of said cylindrical portion (11), the more a wall thickness of said cylindrical portion (11) increases.

2. An optical fiber connecting sleeve (10) comprising a cylindrical portion (11), wherein: said cylindrical portion (11) is provided with a slit portion (12) which extends in a longitudinal direction of said cylindrical portion (11); and, a center point of an inner diameter of said cylindrical portion (11) is deviated from a center point of an outer diameter of said cylindrical portion (11) in cross section.

3. A method of producing an optical fiber connecting sleeve (10), comprising the steps of:
forming a plate-like segment (30), wherein said plate-like segment (30) is provided with a lower flat surface (21) and an upper convex surface (22) to define a wall thickness therebetween in cross section and has its intermediate portion be larger in wall thickness than each of its opposite end portions; and
bending said plate-like segment (30) downward to form a cylindrical portion (11) in a manner such that said opposite end portions of said plate-like segment (30) are oppositely disposed from each other through a clearance (12), wherein said clearance (12) extends in a longitudinal direction of said cylindrical portion (11).

4. A method of producing an optical fiber connecting sleeve (10), comprising the steps of:
forming a plate-like preform (20), wherein said plate-like preform (20) is provided with a lower flat surface (21) and a upper convex surface (22) to define a wall thickness therebetween in cross section and has its intermediate portion be larger in wall thickness than each of its opposite end portions;
dividing said plate-like preform (20) along a plurality of cutting planes into a plurality of plate-like segments (30) each of which is provided with a lower divided flat surface (21), an upper divided convex surface (22) and said opposite end portions, wherein an upper end line of said cutting plane appears in said upper divided convex surface (22) of said plate-like segment (30) to extend over the entire length of each of said upper divided convex surface (22), said lower divided flat surface (21) being provided with a tapered surface (16) adjacent to said cutting plane; and
bending said plate-like segment (30) downward to form a cylindrical portion (11) in a manner such that opposite end portions of said plate-like segment (30) are oppositely disposed from each other through a clearance (12), wherein said clearance (12) extends in a longitudinal direction of said cylindrical portion (11).
